(19) United States
(12) Patent Application Publication
(10) Pub. No.: US 2003/0084167 A1
(43) Pub. Date: May 1, 2003

(54) System, method, apparatus and means for information transmission over a computer network

(76) Inventor: Jay S. Dweck, Armonk, NY (US)

Correspondence Address: BUCKLEY, MASCHOFF, TALWALKAR, & ALLISON, 5 ELM STREET, NEW CANAAN, CT, 06840, US

(21) Appl. No.: 10/041,835

(22) Filed: Oct. 25, 2001

(51) Int. Cl. G06F 15/16

(52) U.S. Cl. 709/228

(57) ABSTRACT

A network communication system, method, apparatus and means is provided which includes identifying, for a communication session, an originator and a participant. A reciprocity rule for the communication session is established, and the communication session is conducted based on the reciprocity rule. The reciprocity rule may be, for example, a rule preventing the participant from sending a message to the originator during the communication session. The reciprocity rule may also be, for example, a rule allowing the participant to send a message to the originator during the communication session. Other rules may also be provided to govern communications during a communication session pursuant to embodiments of the present invention.

### FIELD OF THE INVENTION

The present invention relates to the transmission of information over networks. In particular, embodiments of the present invention relate to the transmission of information between participants over computer networks.

### BACKGROUND OF THE INVENTION

Advances in technology have given individuals and entities a large number of different communication modes to choose from. Many of these communication modes allow peer-to-peer communication where a sender can direct information to an intended recipient. Wired and wireless telephones are one example of such a communication mode. Advances in network technologies such as the Internet have led to the creation of several more recent modes, including electronic mail, Internet Relay Chat (“IRC”, or “chat”), and instant messaging (“IM”). IM is becoming an increasingly popular mode of communication over the Internet, offering the convenience of electronic mail and the real-time nature of a telephone call.

Some of these modes of communication involves require the presence of both participants (the sender and the receiver); others do not require the presence of the receiver for communication to be delivered. For example, electronic mail and voice mail messages may be sent, and delivered, without the presence of the receiver. Voice telephone calls, chat, and IM communications require that both participants be present.

Some modes of communication involve one to one communication. Others allow one to many, or even many to many communications. An example of one to one communication is a voice telephone conversation between two participants. An example of one to many communication is a television broadcast. An example of many to many communication is an Internet chat room. Some of these modes of communication are non-reciprocal and only allow for communication in a single direction (e.g., a television broadcast). Other modes allow for reciprocal communication among multiple participants (e.g., such as a telephone call, chat room, or the like).

Both reciprocal and non-reciprocal communications may be broadcast or targeted. Broadcast communications are directed to non-specific recipients, such as a television broadcast provided to any individual able to tune into a particular broadcast. Targeted communications are those which are directed to particular recipients, such as an electronic mail message directed to a particular list of intended recipients, or an IM message to a friend who is currently on-line.

Unfortunately, some modes of communication which utilize computer networks (such as the Internet) do not allow non-reciprocal communications. For example, the increasingly popular IM services offered by America On-Line® and Microsoft® require that both the sender and the intended recipient be on-line at the same time to initiate an IM discussion. Each of these services allow an individual to communicate with a select subset of individuals (referred to as the “Buddy List” in the America On-Line system). The Buddy List essentially is an address book identifying a participant's list of specific recipients. An IM can be sent from the individual to one or more of the specific recipients in the Buddy List. These systems also support chat room conversations where one sender communicates with a plurality of recipients (again, via the address book). These types of network communication require the identification of specific recipients, typically listed in the originator's address book.

Each of these types of network communication require reciprocity in transmissions. That is, the originator is able to both send information to and receive information from his recipients. In some environments, this reciprocity can pose a problem for the originator—he may not wish to receive messages from his recipients. It may be unproductive or counterproductive for certain types of originators to receive information from his recipients. For example, an originator who communicates with a number of clients to distribute financial information may not wish to receive responses from each and every client. As another example, in some environments, an originator's network system may be overly taxed or burdened if every recipient of the originator's communications were able to reply to the originator.

It would be advantageous to provide a method and apparatus that overcame the drawbacks of the prior art. It would be desirable to provide a system and method which allows non-reciprocal communications over computer networks such as the Internet. It would also be desirable to provide a system and method which allows an originator of the non-reciprocal communication to modify the status of communication during transmission.

### SUMMARY OF THE INVENTION

To alleviate the problems inherent in the prior art, and to allow non-reciprocal communication between participants, embodiments of the present invention provide a system, method, apparatus and means for information transmission over a computer network.

In one embodiment, a network communication system, method, apparatus and means is provided which includes identifying, for a communication session, an originator and a participant. A reciprocity rule for the communication session is established, and the communication session is conducted based on the reciprocity rule. The reciprocity rule may be, for example, a rule preventing the participant from sending a message to the originator during the communication session. The reciprocity rule may also be, for example, a rule allowing the participant to send a message to the originator during the communication session. Other rules may also be provided to govern communications during a communication session pursuant to embodiments of the present invention.

In some embodiments, the reciprocity rule may be modified during the course of the communication session. In some embodiments, a number of reciprocity rules may be established for a number of participants. In some embodiments, different classes of participants may be associated with different reciprocity rules.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

FIG. 1 is a flow diagram illustrating an exemplary process for communication between participants according to some embodiments of the present invention;

FIG. 2 is a block diagram of a system consistent with the present invention;

FIGS. 3A-B are block diagrams of embodiments of the system depicted in FIG. 1;

FIG. 4 is a block diagram of one embodiment of a participant device for use in the present invention; and

FIG. 5 is a flow diagram illustrating an exemplary process for communication between participants according to some embodiments of the present invention.

### DETAILED DESCRIPTION OF THE INVENTION

Applicants have recognized that there is a need for network communication systems and methods which allow participants in a communication session to designate reciprocity rules for the session. In addition, Applicants have recognized that there is a need for network communication systems and methods which allow participants to modify reciprocity rules during the course of a communication session.

One benefit of embodiments of the present invention is that participants, such as originators of messages in a communication session, may prevent some or all recipients of a message from responding to communications sent by the originator. As a result, communication sessions may be established and maintained between an originator and a large number of participants, without exposing the originator to an unwieldy number of unwanted responses. Further, the originator may selectively establish direct communications between specific intended participants during the course of a communication session. Other features and advantages will become apparent to those skilled in the art upon reading this disclosure.

A number of terms are used herein to describe features of embodiments of the present invention. As used herein, the term “communication session” (or, simply, “session”) is used to refer to a particular series of messages transmitted among participants. A communication session may be defined by a participant originating or establishing communication pursuant to embodiments of the present invention, or it may be defined by a network or system operator facilitating communication among participants. In some embodiments, a communication session may consist of a number of related messages among participants (e.g., related based on subject matter, topic, date, time, or the like). As used herein, the term “link” is used to refer to communication between two participants in a communication session. As used herein, a link may be “symmetric” or “reciprocal” (e.g., both parties have the same ability to send each other messages), or it may be “asymmetric” or “non-reciprocal” (e.g., the two parties have different abilities to send each other messages).

As used herein, an “originator” or “initiator” of a communication session pursuant to embodiments of the present invention may be an individual, entity or device which initiates or originates a session pursuant to embodiments of the present invention. A session may be initiated or originated in a number of ways, including, for example: by the act of sending a first message in a session; by the act of identifying a session and its participants; by the act of responding to a message; by the act of opening a message; or by some other action.

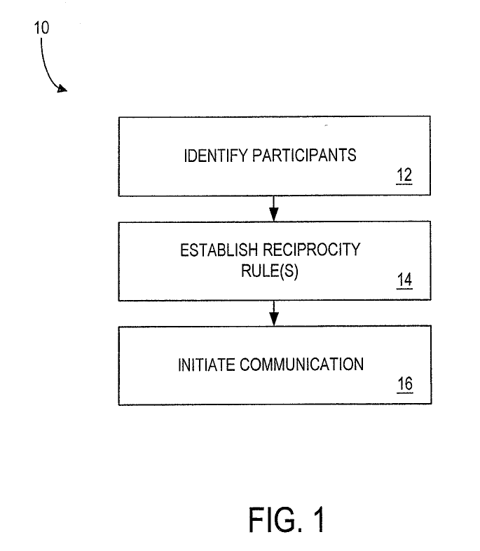

A description of a method pursuant to some embodiments of the present invention will now be provided by referring to flow chart 10 in FIG. 1. The particular arrangement of elements in the flow chart of FIG. 1 is not meant to imply a fixed order to the steps; embodiments of the present invention can be practiced in any order that is practicable.

Pursuant to some embodiments of the present invention, participants in a communication session conducted over a network may establish one or more reciprocity rules governing communications during the session. As depicted, the process begins at 12 where participants in the communication session are identified. This may be performed, for example, under the control or direction of the participant who is initiating, directing, or otherwise organizing the communication session (which participant is generally referred to herein as the “originator”). In some embodiments, the originator may activate terminal software to facilitate this communication. In some embodiments, the originator may select from a number of participant identifiers previously stored in an address book or address listing. In some embodiments, the participants (including the originator) are identified by a unique identifier for each session. In some embodiments, each of the participants are identified by a unique identifier which is used across different sessions. Each participant is also identified by an address, such as, for example, an Internet electronic mail address, an Internet Protocol (IP) address, or some other network identifier allowing the routing of messages to a particular participant during the course of a communication session.

Processing continues at 14 where one or more reciprocity rules are established. In some embodiments, reciprocity rules are established for each session. In some embodiments, reciprocity rules are established for each participant, across multiple sessions. In some embodiments, establishment of reciprocity rules at 14 is performed by the originator for each of the participants selected at 12. Once the desired reciprocity rules have been established, processing continues at 16 where the communication session is initiated. This communication session is conducted such that it involves the participants identified at 12 and pursuant to the reciprocity rules established at 14. In some embodiments, the reciprocity rules may be modified, deleted, or otherwise amended during the course of the communication session. The result is a communication session which is conducted pursuant to desired reciprocity rules, allowing the structure and conduct of organized, orderly, and efficient network communication between a number of individuals.

An illustrative example of a particular type of communication session which may benefit from embodiments of the present invention will now be presented where the originator is a financial analyst working for an investment bank. The financial analyst may service and regularly communicate with a number of investors and media representatives. The financial analyst may, for example, transmit financial data and reports to investors and media representatives and may also transmit pictures and videos supporting or explaining the data. However, the financial analyst may not wish to receive return communications from each of the participants as the number of responses could overwhelm the financial analyst or the computer network of the investment bank. As a result, direct electronic mail communications to each of the participants would not be satisfactory, nor would existing chat room or IM techniques.

Pursuant to embodiments of the present invention, the financial analyst may establish a list of participants in a communication session (e.g., by selecting the participants from an electronic address book). The financial analyst may then establish one or more reciprocity rules governing the ability of each of the participants to engage in reciprocal communication with the analyst. For example, the financial analyst may identify several important media representatives as deserving or requiring reciprocal communication rights, and block or prevent all of the other participants from engaging in reciprocal communication with the analyst. In some embodiments, these reciprocal rights are associated with individual participant identifiers. The financial analyst may also designate particular reciprocity rules for entire groups or classes of participants (e.g., all retail investors may be prevented from sending messages to the analyst, while all commercial investors and media representatives are allowed to send messages to the analyst).

Once these rules are established, the analyst may initiate a communication session with the participants. In some embodiments, the communication session is conducted generally based on IM or chat room message formats generally known in the art.

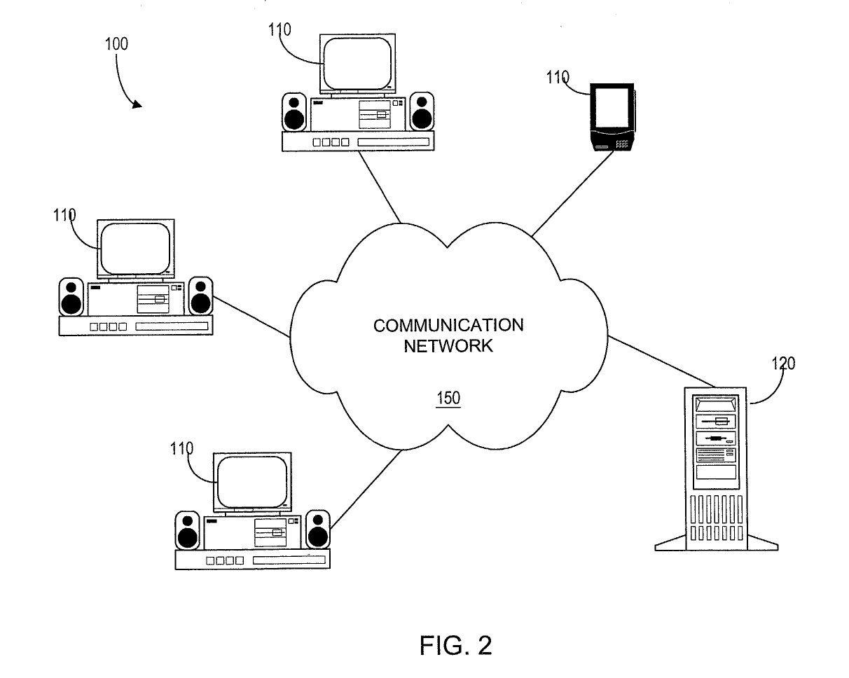

Referring now to FIG. 2, a system 100 according to embodiments of the present invention includes a number of participant devices 110 that are in communication with each other and with one or more servers 120 via a communication network 150.

As used herein, communication network 150 may employ any of a number of different types and modes of communication, and may be for example, a Local Area Network (LAN), a Metropolitan Area Network (MAN), a Wide Area Network (WAN), a proprietary network, a Public Switched Telephone Network (PSTN), a Wireless Application Protocol (WAP) network, a wireless network, a cable television network, or an Internet Protocol (IP) network such as the Internet, an intranet or an extranet. Moreover, as used herein, communications include those enabled by wired or wireless technology.

Any of a number of different types of participant devices 110 may be used to communicate using features of embodiments of the present invention. For example, in some embodiments, participant device 110 may be a computer, such as those based on the Intel® Pentium® processor, that are adapted to communicate via network 150. The computer may be configured in any of a number of different manners, such as, for example, as a desk-top computer, lap-top computer, handheld computer, personal digital assistant (PDA), or the like. Each participant device 110 may operate software applications allowing the device to communicate via network 150 and to send and receive messages pursuant to embodiments of the present invention.

Server 120 may be configured in any of a number of ways known to those skilled in the art, such as, for example, an Intel® Pentium® based-computer or the like. In some embodiments, one or more participant devices 110 interact with one or more servers 120 in a client-server relationship to transmit and receive messages pursuant to embodiments of the present invention. In some embodiments, one or more participant devices 110 interact directly with each other in a peer-to-peer relationship. Any number of participant devices 110 and servers 120 may be in communication via network 150.

Server 120 may function as a “Web server” that generates Web pages (documents on the Web that typically include an HTML file and associated graphics and script files) that may be accessed via the Web and allows communication with participant devices 110 in a manner known in the art. One or more servers 120 may be operated by, for example, Internet Service Providers (ISPs) or other entities which facilitate and offer messaging services pursuant to embodiments of the present invention. In some embodiments, server 120 may operate to coordinate IM messages and/or to track the identity and status of participants. For example, in some embodiments, server 120 is used to maintain reciprocity rules and address information for participants in communication sessions operated pursuant to the present invention. Each participant is assigned an identifier. A participant who originates a communication session may interact with server 120 via participant device 110 and establish one or more reciprocity rules for the session. The originator also interacts with server 120 via participant device 110 to select one or more participants to take part in the communication session. The originator may then associate reciprocity rules with one or more participants. As an example, an originator having a user identifer of “P001” and an IP address of “P001@IM.com” desiring to establish a communication session involving three other participants may establish the rules for each of the participants by interacting with server 120 to arrive at stored information associating reciprocity rules with particular participants in a communication session, such as depicted in TABLE 1:

TABLE 1

| Session | Participant | Participant Address | Reciprocity Rule |
|---|---|---|---|
| S001 | P00A | P001A@IM.com | Send / receive all |
| S001 | P00B | P00B@co.com | Receive all |
| S001 | P00C | P00C@corp.com | Send / Receive all |
| S001 | P00N | P00N@firm.com | Receive all |

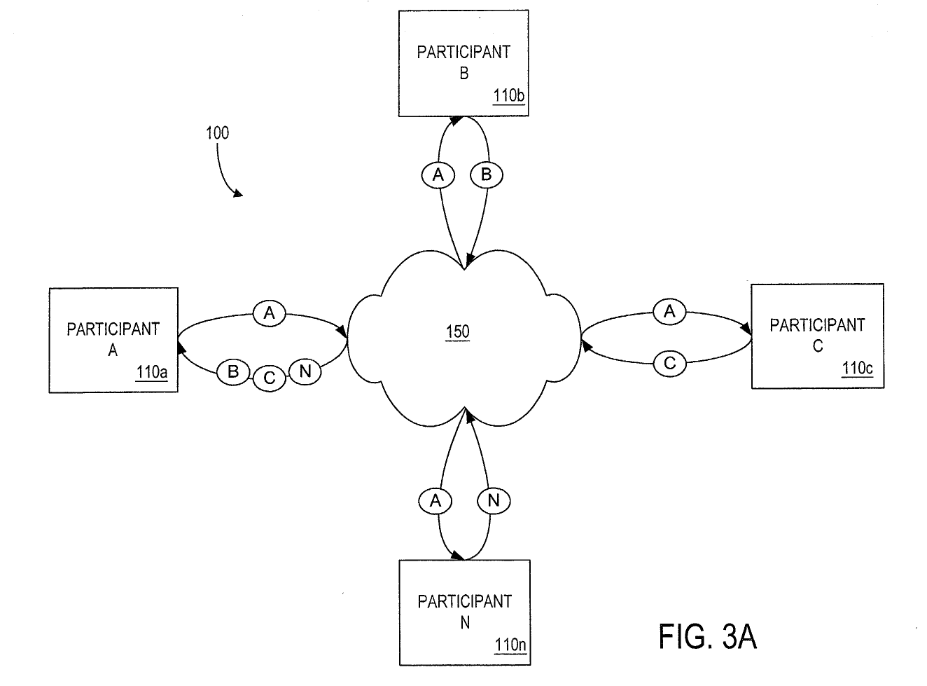

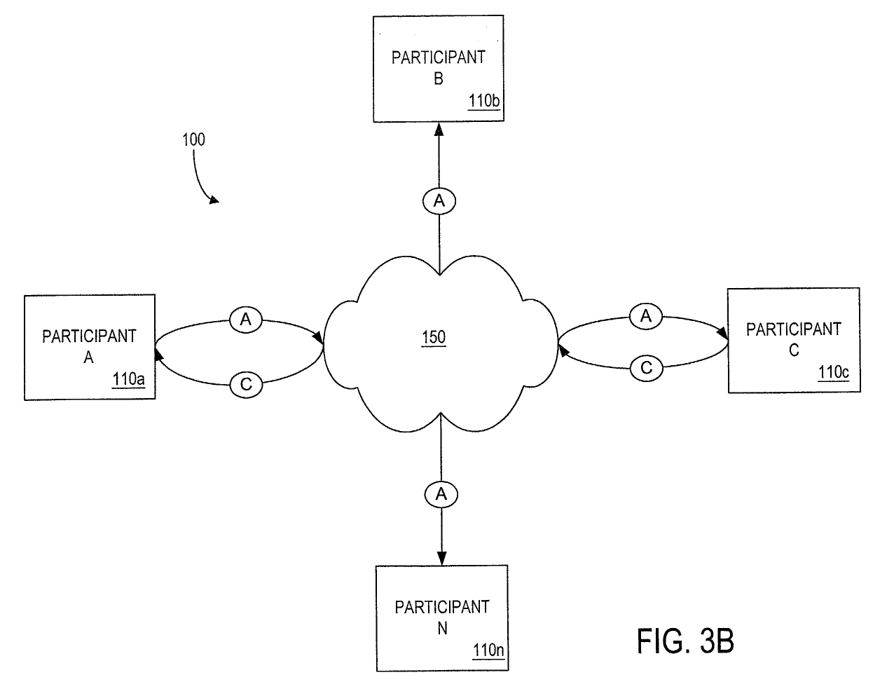

An example of a communication session conducted over network 150 using participant devices 110 pursuant to embodiments of the present invention will now be described by referring to FIGS. 3A and 3B. In FIG. 3A, a system 100 includes several participants, participants A, B, C and N, each operating participant devices 110a-n, respectively. Each participant device 110 is in communication with network 150, allowing each participant device 110 to send and receive messages. As depicted, participant A is the originator of the communication session, and participants B, C and N are participants in the session. In the example communication session, each of-the participants as reciprocal communication rights with participant A. For example, participant C is able to receive messages from participant A and is also able to send messages to participant A.

Referring now to FIG. 3B, an example of a communication session is shown in which reciprocity rules pursuant to embodiments of the present invention have been imposed. In the example session, participant A is again the originator of the session, and may send messages to each of the participants in the session (including participants B, C, and N). In this example, however, participant A, pursuant to embodiments of the present invention, has imposed restrictions on the ability of several of the participants to send messages to the originator (participant A). In particular, participants B and N do not have reciprocity with participant A.

These communication links between participants A and B, and between participants A and N are referred to herein as “asymmetrical”. Participant C, on the other hand, enjoys reciprocal rights with participant A, and may send messages to participant A as well as receive messages from participant A. This communication link between participant A and participant C is referred to herein as “symmetrical”. An example data structure used to associate particular reciprocity rules with each participant in a communication session is depicted as TABLE 1 above. The example entries and data formats are for illustrative purposes only; those skilled in the art will recognize that a wide variety of data formats, entries, and arrangements may be used to impose reciprocity rules and restrictions on participants in communication sessions pursuant to the present invention.

In some embodiments, such asymmetric links may be established individually for each particular communication session. That is, the participant acting as a communication session originator may have the ability, at any time, to make a link reciprocal, non reciprocal, etc. The originator may choose to establish non-reciprocal links at the very beginning of the communication session, for example, or may establish a non-reciprocal link during the course of a communication session. Moreover, when the originator is communicating with more than one other participant, the originator may elect to establish symmetric communication with one or more participants and asymmetric communication with one or more other participants.

To establish the particular recipients, and the nature of their transmissions, some embodiments of the present invention present the originator with a list, similar to an address list, with each of the other participants who will be included in a communication session. The originator may then modify or alter reciprocity rules associated with each of the participants. For example, reciprocity rules may be established which indicate whether a particular participant is to be allowed to send messages to the originator or whether the particular participant is to be denied the ability to send messages to the originator. In some embodiments, the originator may be presented with a form, viewable on his Internet browser, messaging software interface, or other software, which allows the originator an easy interface to establish reciprocity rules for each participant. In some embodiments, the originator may establish reciprocity rules for different groups or classifications of participants. For example, a financial analyst may wish to provide reciprocity to all participants classified as “media representatives” and may wish to deny reciprocity to all participants classified as “retail investors”.

In some embodiments, asymmetric links may be established automatically. For example, an originator may have a regularly scheduled Web cast that links with various recipients, such as a corporate earnings conference Web cast. Some of the transmissions may be through reciprocal links, established with preferred customers, who could then interact by asking questions, asking for further information, etc. Other transmissions may be through non-reciprocal links, established with non-preferred customers, who receive the transmission from the originator but are unable to reply in a reciprocal manner. The establishment of the reciprocal and non-reciprocal links in this example is done automatically at the beginning of the Web cast. In some embodiments, the establishment of reciprocity rules will depend upon the type of event. In some embodiments, the automatic establishment of reciprocity rules may be event driven, that is, the nature of the communication session will depend upon the nature of the event. Event driven reciprocity rules are not limited to automatic preferences, however, and may be used in a manual setting as well.

It should be noted that a participant may or may not be aware, as is desired by the originator, of the type of reciprocity which the originator has granted the participant (e.g., whether the link is symmetric or asymmetric). For example, if a communication session will involve a large number of links and participants and where some of the links are symmetric and others are asymmetric, the originator may not wish for any given participant to know his or her reciprocity status. In some embodiments, a third party, (such as an administrator or other entity) establishes the reciprocity rules for a particular communication session or sessions.

Communications in a communication session established pursuant to embodiments of the present invention may occur using any of a number of different types of media. For example communication sessions may include the transmission of text, audio, video, or other media types, or any combination thereof. Nor is it necessary for the media to be the same in each message. For example, there may be different media used for different recipients during a Web cast.

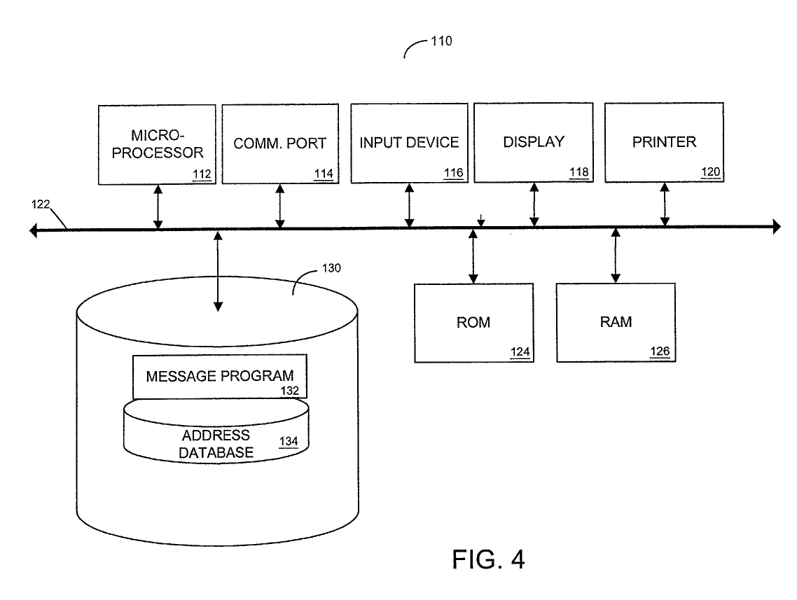

FIG. 4 illustrates an embodiment of a participant device 110. Any or all of the participant devices 110 may be implemented as a system controller, a dedicated hardware circuit, an appropriately programmed general purpose computer, or any other equivalent electronic, mechanical or electromechanical device. As illustrated, participant device 110 includes a microprocessor 112 in communication with a communication bus 122. Microprocessor 112 may be a Pentium®, RISC®-based, or other type of processor and is used to execute processor-executable process steps so as to control the components of participant device 110 to provide desired functionality.

Also in communication with communication bus 122 is a communication port 114. Communication port 114 is used to transmit data to and to receive data from external devices, such as, for example, other participant devices 110 via a network such as the Internet. Communication port 114 is therefore preferably configured with hardware suitable to physically interface with desired external devices and/or network connections. In one embodiment, messages pursuant to embodiments of the present invention are transmitted and received by participant 110 via communication port 114.

An input device 116, a display 118 and a printer 120 are also in communication with communication bus 122. Any known input device may be used as input device 116, including a keyboard, mouse, touch pad, voice-recognition system, or any combination of these devices. Input device 116 may be used by an participant (such as an originator or a receiver) to input message information and messaging instructions pursuant to embodiments of the present invention.

Messages and message instructions may be output and displayed to a participant operating participant device 110 via display 118, which may be an integral or separate CRT display, flat-panel display or the like. Display 118 is used to output graphics and text to a participant operating device 110 in response to commands issued by microprocessor 112. Printer 120 is also an output device, and may be used to produce hardcopy output of data using ink-jet, thermal, dot-matrix, laser, or other printing technologies.

Participant device 110 also includes memory devices coupled to communication bus 122, such as, for example random-access memory (RAM) 126, read-only memory (ROM) 124, and data storage device 130. RAM 126 may be used, for example, to provide microprocessor 112 with fast data storage and retrieval. In this regard, processor-executable process steps being executed by microprocessor 112 are typically stored temporarily in RAM 124 and executed therefrom by microprocessor 112. ROM 124 may be utilized to provide storage from which data can be retrieved but to which data cannot be stored. Accordingly, ROM 124 is typically used to store invariant process steps and other data, such as basic input/output instructions and data used during system boot-up or to control communication port 114.

Data storage device 130 stores, among other data, a message program 132 including processor-executable process steps used to provide messaging functionality pursuant to embodiments of the present invention. According to some embodiments, these process steps of message program 132 may be read from a computer-readable medium, such as a floppy disk, a CD-ROM, a DVD-ROM, a Zip disk, a magnetic tape, or a signal encoding the process steps, and then stored in data storage device 130. Microprocessor 112 executes stored instructions to cause participant device 110 to operate in accordance with the process steps described in detail herein.

Data storage device 130 may also store data, such as, for example, an address database 134, which includes address information and other data used by message program 132 to achieve the functionality described herein. For example, in some embodiments, data storage device 130 may store information similar to that depicted above in conjunction with TABLE 1. Data and instructions in data storage device 130 may be stored in a compressed, uncompiled and/or encrypted format. In alternative embodiments, hard-wired circuitry may be used in place of, or in combination with, processor-executable process steps for implementation of the processes of the present invention. Thus, embodiments of the present invention are not limited to any specific combination of hardware and software.

Data storage device 130 also includes elements that may be necessary for operation of participant device 110, such as other applications, data files, an operating system, a database management system and “device drivers” for allowing microprocessor 112 to interface with devices in communication with communication port 114. These program elements are known to those skilled in the art, and are therefore not described in detail herein.

Server 120 (FIG. 2) may be configured with similar elements as described for participant device 110 (e.g., each server may include a processor, communications port, input and output devices, and memory storing instructions and data to achieve the functionality described herein). In some embodiments, server 120 stores data such as the data depicted above in conjunction with TABLE 1 which is used to establish, monitor, and enforce reciprocity rules for particular communication sessions and participants.

The following is an example which illustrates additional embodiments of the present invention. The examples set forth herein do not constitute a definition of all possible embodiments, and those skilled in the art will understand that the present invention is applicable to many other embodiments. Further, although the examples set forth herein are briefly described for clarity, those skilled in the art will understand how to make any changes, if necessary, to the apparatus and methods described herein to accommodate these and other embodiments and applications.

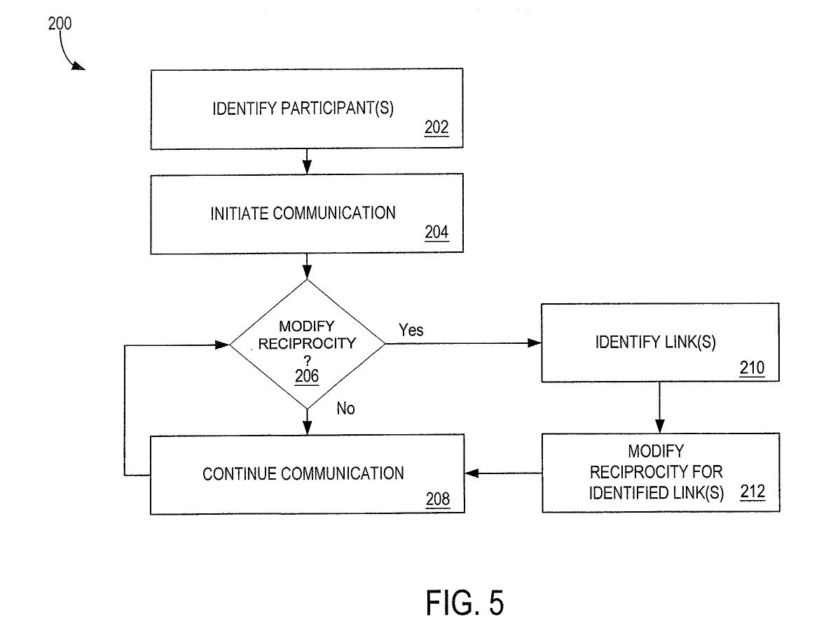

Referring now to FIG. 5, a messaging method 200 according to some embodiments of the present invention is shown. In the depicted embodiment, messaging method 200 allows the modification of reciprocity rules during the course of a communications session. For example, an originator of a communication session may choose to utilize features of the present invention to initiate communication with a number of participants, and then during the conduct of the session, may remove or add reciprocity rules to manage the session in an organized fashion.

Method 200 begins at 202 where one or more participants of the communication session are identified. For example, this may be performed by the individual or entity acting as the originator by interacting with an address list of potential participants. In some embodiments, processing at 202 may also include establishing one or more reciprocity rules for each individual identified as a participant in the communication session. In some embodiments, the participants identified at 202 are participants who have been identified as being “on-line” and available for participation in an IM communication session. In some embodiments, the connection status of the participants identified at 202 is unknown.

Processing continues at 204 where communication with the participants identified at 202 is initiated. Communication may be initiated using IM techniques or other communication techniques. According to some embodiments, this communication may continue until the originator (or another authorized entity) chooses to modify one or more reciprocity rules (or terminate the session). For example, a financial analyst who has established a communication session with a number of participants including investors and media representatives may initiate the session with all participants having no reciprocity (e.g., no participant may send the financial analyst a message). Near the end of the communication session, the analyst may choose to open a question and answer period and allow one or more participants to submit questions to the analyst. Pursuant to embodiments of the present invention, the analyst may do this by choosing to modify one or more reciprocity rules at 206, identifying the communication link(s) to modify at 208, and modifying the reciprocity for the identified links at 210.

Processing at 206, 208 and 210 may be performed by interacting with messaging software resident at the originator's participant device or by interacting with messaging software resident at a server device. In some embodiments, links may be identified by identifying particular participants for which the reciprocity is to be modified.

Processing continues at 208 where the communication session continues until the session is terminated or until the originator (or other authorized individual or entity) chooses to further modify reciprocity (e.g., the analyst may choose to close the question and answer session and remove all reciprocity). The result is a system and method which allows control over the conduct of a messaging session involving multiple participants.

Although the present invention has been described with respect to a preferred embodiment thereof, those skilled in the art will note that various substitutions may be made to those embodiments described herein without departing from the spirit and scope of the present invention.

What is claimed is:

1. A network communication method, comprising:
identifying, for a communication session, an originator and a participant;
establishing a reciprocity rule for said communication session; and
conducting said communication session involving said originator and said participant based on said reciprocity rule.

2. The method of claim 1, wherein said identifying further comprises identifying a plurality of participants and wherein said conducting further comprises involving said plurality of participants.

3. The method of claim 2, further comprising establishing a plurality of reciprocity rules.

4. The method of claim 1, wherein said identifying further comprises:
selecting said participant from an address book.

5. The method of claim 1, wherein said reciprocity rule is a rule preventing said participant from sending a response message to said originator.

6. The method of claim 1, wherein said reciprocity rule is a rule permitting said participant to send a response message to said originator.

7. The method of claim 1, wherein said communication session is an Internet instant messenger session.

8. The method of claim 1, further comprising:
modifying said reciprocity rule during said communication session.

9. A communication device operated by an originator of a communication session, comprising:
a processor; and
a storage device coupled to said processor and storing instructions adapted to be executed by said processor to:
identify, for said communication session, at least a first participant;
establish a reciprocity rule for said communication session; and
conduct said communication session involving said originator and said participant based on said reciprocity rule.

10. The communication device of claim 9, further comprising-instructions adapted to be executed by said processor to:
modify said reciprocity rule during said communication session.

11. The communication device of claim 9, wherein said reciprocity rule is a rule preventing said at least first participant from replying to a message from said originator.

12. The communication device of claim 9, wherein said reciprocity rule is a rule allowing said at least first participant to reply to a message from said originator.

13. The communication device of claim 9, further comprising:
a communication port coupled to said processor and adapted to communicate with at least one of: a messaging server, and a participant device.

14. The communication device of claim 9, wherein said storage device further stores an address book containing a plurality of participant addresses.

15. A messaging system, comprising:
an originator device having a processor and a storage device, said storage device storing instructions adapted to
identify at least a first participant in a communication session;
establish a reciprocity rule for said at least first participant for said communication session;
send at least a first message to said at least first participant in said communication session; and
a participant device having a processor and a storage device, said storage device storing instructions adapted to
receive said at least first message; and
process a response to said at least first message based on said reciprocity rule.

16. The messaging system of claim 15, wherein said storage device of said originator device further stores instructions adapted to modify said reciprocity rule during said communication session.

17. The messaging system of claim 15, wherein said reciprocity rule prevents a response from said at least first participant.

18. The messaging system of claim 15, wherein said reciprocity rule allows a response from said at least first participant.

19. A computer-readable medium that stores data accessible by a program executable on a data processing system to perform a communication method, the method comprising:
identifying, for a first communication session, an originator and a participant;
establishing a reciprocity rule for said communication session; and
conducting said communication session involving said originator and said participant based on said reciprocity rule.

20. A computer-implemented method, comprising:
receiving, from an originator, information identifying a plurality of participants in a communication session;
receiving, from said originator, reciprocity rule information for each of said plurality of participants;
forwarding a message from said originator to each of said plurality of participants; and
processing responses from each of said plurality of participants based on said reciprocity rule information.

21. A network communication method, comprising;
identifying an originator and at least a first participant;
establishing reciprocity rules between said originator and said at least first participant; and
conducting a network communication between said originator and said at least first participant pursuant to said reciprocity rules.
